(19) United States
(12) Patent Application Publication
(10) Pub. No.: US 2011/0043528 A1
(43) Pub. Date: Feb. 24, 2011

(54) CACHE MANAGEMENT FOR GLYPH DISPLAY

(75) Inventors: Dmitriy Solomonov, Sunnyvale, CA (US); Michael Ingrassia, San Jose, CA (US); James Eric Mason, Campbell, CA (US)

Correspondence Address: KRAMER LEVIN NAFTALIS & FRANKEL LLP, 1177 Avenue of the Americas, New York, NY, 10036, US

(73) Assignee: Apple Inc., Cupertino, CA (US)

(21) Appl. No.: 12/546,076

(22) Filed: Aug. 24, 2009

(51) Int. Cl. G09G 5/36

(52) U.S. Cl. 345/467; 345/557

(57) ABSTRACT

This is directed to managing a cache size for glyphs used to display text or other information in an electronic device. In particular, this is directed to defining a variable hit rate for retrieving glyphs loaded in cache to limit the number of times the device is required to read glyphs from storage. The hit rate can vary based on any suitable number or type of factors, including for example the characters previously displayed or to be displayed in the future, the system requirements for system memory, or any other suitable factor. In some embodiments, the hit rate can vary when characters in a second alphabet are displayed among or after characters in a first alphabet (e.g., Japanese characters in a listing of Latin characters).

### FIELD OF THE INVENTION

This is directed to managing font caching to reduce the number of disk accesses while limiting the size of the cache. In particular, this is directed to defining a variable target hit rate for accessing glyph bitmaps from cache, and varying the size of the cache based on the difference between the actual hit rate and the target hit rate.

### BACKGROUND OF THE INVENTION

Using an electronic device, a user can display different types of information. For example, the electronic device can display graphics, text, or other information of interest to a user. The displayed information can be displayed as a collection of primitive elements (e.g., glyphs) drawn on a page at defined locations. In some cases, the electronic device can operate in several languages (e.g., English, French, Chinese, Japanese, and Arabic) and can display text in each of the languages using one or more different fonts. Each character of each language can be represented by a different glyph. In addition, different sizes and styles of a character in each font can be represented by one or more different glyphs. The glyphs can be defined using any suitable approach. In some embodiments, a glyph can be defined using an 8-bit bitmap that is associated with a particular typeface character, font and size. In another embodiment, a glyph can be defined using path data associated with a particular typeface character and font that can be resized based on the requested size.

The glyphs can be stored by the device using any suitable approach. In some embodiments, glyphs can initially be stored on a storage drive (e.g., a hard drive or solid state drive). When the device requires a particular glyph for display, the device can retrieve the glyph from storage and load it into a system memory (e.g., a cache). This approach, however, can require constant reading and writing from and to storage, which can be time consuming and power-intensive. Alternatively, all of the glyphs required for displaying information to a user can be loaded into system memory ahead of an expected system request to reduce the number of read from storage. This approach, however, can require a large cache. In particular, a very large cache may be required when non-Latin alphabets are used (e.g., for Chinese, Korean or Japanese characters). When the device only requires few non-Latin characters (e.g., Chinese characters for a single artist and song title), it may be a waste of resources to load the entire collection of non-Latin glyphs in cache.

### SUMMARY OF THE INVENTION

This is directed to systems, methods and computer-readable media for selecting a particular subset of glyphs to retain stored in cache. In particular, this is directed to a variable hit rate specifying a target number of glyphs to retain in cache, such that the target causes the size of the cache to change.

Using a display, an electronic device can display glyphs representing different characters combining to provide information to a user of the device. For example, the electronic device can display bitmap glyphs each associated with a particular character, font and size. As another example, the electronic device can display glyphs defined using path data, such that each glyph is associated with a particular character and font (but not a particular size, as the path data can allow the device to trace the character in any size). Initially, glyphs associated with the characters available for display by the device can be written to storage (e.g., a hard drive or solid state drive), for example as part of the firmware, software (e.g., an operating system), or other code operating the device. To display information (e.g., characters) on a device display, the device can read from storage the glyphs corresponding to the characters needed and load it into a system memory or cache for access by the display processing circuitry and code.

The electronic device can load some or all of the glyphs in cache at any suitable time. For example, the device can load all of the available glyphs in cache upon start-up. Alternatively, the device can load glyphs in cache in response to a request from system memory for a particular glyph (e.g., associated with text in a menu that is to be displayed). These approaches, however, can be limiting in that the first requires a very large cache (using up system memory, which may be in limited quantity), and the second requires constant or significant storage access (e.g., reading from storage using up power and delaying the display of the glyphs).

To reduce the number of storage accesses (e.g., to read glyphs from storage) while limiting the size of cache, the electronic device can vary the size of the cache, and thus the number of glyphs stored in cache based on the display requirements of the user interface. The electronic device can define the size of the cache using any suitable approach. In one embodiment, the size of the cache can be determined based on the hit rate or success rate of finding a required glyph in cache (e.g., and thus not needing to read the glyph from storage). If at least a number of glyphs matching the hit rate are available from cache, the device can retain the current size of the cache. If too few glyphs are available from cache, the device can increase the size of the cache. If too many glyphs are available from cache, the device can reduce the size of the cache.

In some embodiments, the hit rate can vary based on the type or number of characters to display on a particular interface. For example, if the device requires a different alphabet for several displayed options, the device can change the hit rate (e.g., reduce the hit rate) of the initial alphabet. Alternatively, the device can define different variable hit rates for each of the alphabets, and vary the hit rates of each alphabet based on the particular alphabet used in a current interface. In some embodiments, heuristics can be used to define the manner in which the hit rate varies.

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 is a schematic view of an illustrative electronic device for selecting an area in a display in accordance with one embodiment of the invention;

FIG. 2 is a schematic view of an illustrative electronic device display depicting a text listing in accordance with one embodiment of the invention;

FIG. 3 is a schematic view of an illustrative display depicting a different section of the text listing of FIG. 2 in accordance with one embodiment of the invention;

FIG. 4 is a flowchart of an illustrative process for managing the cache size in accordance with one embodiment of the invention; and

FIG. 5 is a flowchart of an illustrative process for adjusting a target hit rate in accordance with one embodiment of the invention.

### DETAILED DESCRIPTION

This is directed to selectively loading glyphs into cache from storage. In particular, this is directed to managing and varying the cache size based on requests for particular glyphs in displayed user interfaces.

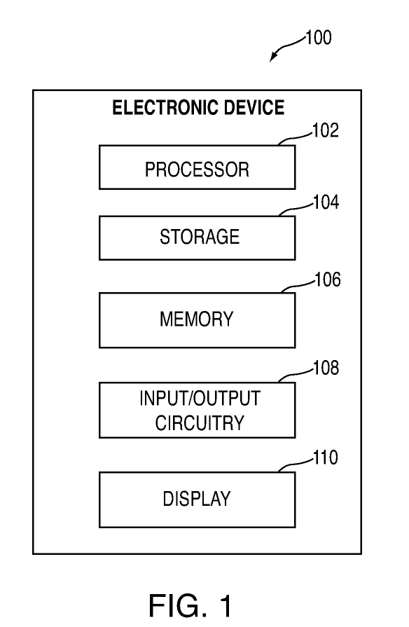

FIG. 1 is a schematic view of an illustrative electronic device for selecting an area in a display in accordance with one embodiment of the invention. Electronic device 100 can include any suitable type of electronic device operative to display information to a user. For example, electronic device 100 can include a media player such as an iPod® available by Apple Inc., of Cupertino, Calif., a cellular telephone, a personal e-mail or messaging device (e.g., a Blackberry® or a Sidekick®), an iPhone® available from Apple Inc., pocket-sized personal computers, personal digital assistants (PDAs), a laptop computer, a music recorder, a video recorder, a gaming device, a camera, radios, medical equipment, and any other portable electronic device having a display from which a user can select a portion of displayed objects.

Electronic device 100 can include a processor or control circuitry 102, storage 104, memory 106, input/output circuitry 108, and display 110 as typically found in an electronic device of the type of electronic device 100, and operative to enable any of the uses expected from an electronic device of the type of electronic device 100 (e.g., connect to a host device for power or data transfers). In some embodiments, one or more of electronic device components 100 can be combined or omitted (e.g., combine storage 104 and memory 106), electronic device 100 can include other components not combined or included in those shown in FIG. 1 (e.g., communications circuitry or positioning circuitry), or electronic device 100 can include several instances of the components shown in FIG. 1. For the sake of simplicity, only one of each of the components is shown in FIG. 1.

Control circuitry 102 can include any processing circuitry or processor operative to control the operations and performance of electronic device 100. Storage 104 can include, for example, one or more storage mediums including a hard-drive, solid state drive, flash memory, permanent memory such as ROM, any other suitable type of storage component, or any combination thereof. Memory 106 can include cache memory, semi-permanent memory such as RAM, and/or one or more different types of memory used for temporarily storing data. In some embodiments, memory 106 and storage 104 can be combined as a single storage medium. Input/output circuitry 108 can be operative to convert (and encode/decode, if necessary) analog signals and other signals into digital data. Input/output circuitry 108 can be coupled to or include any suitable input interface, such as for example, a button, keypad, dial, a click wheel, or a touch screen, as well as any suitable output circuitry associated with output devices (e.g., audio outputs or display circuitry or components).

Display 110 can be operatively coupled to control circuitry 102 for providing visual outputs to a user. Display 110 can include any suitable type of display, including for example a liquid crystal display (LCD) (e.g., active matrix, passive matrix and the like), a monochrome display, color graphics adapter (CGA) display, enhanced graphics adapter (EGA) display, variable-graphics-array (VGA) display, super VGA display, cathode ray tube (CRT), a plasma display, a display implemented with electronic inks, or any other suitable display. Display 110 can be configured to display a graphical user interface that can provide an easy to use interface between a user of the computer system and the operating system or application running thereon. The UI can represent programs, files and operational options with graphical images, objects, or vector representations, and can include windows, fields, dialog boxes, menus, icons, buttons, cursors, scroll bars, etc. Specific characters defining text in one or more languages, as well as other information displayed to the user can be provided by glyphs retrieved from storage.

In some embodiments, electronic device 100 can include a bus operative to provide a data transfer path for transferring data to, from, or between control processor 102, storage 104, memory 106, input/output circuitry 108, display 110 and any other component included in the electronic device.

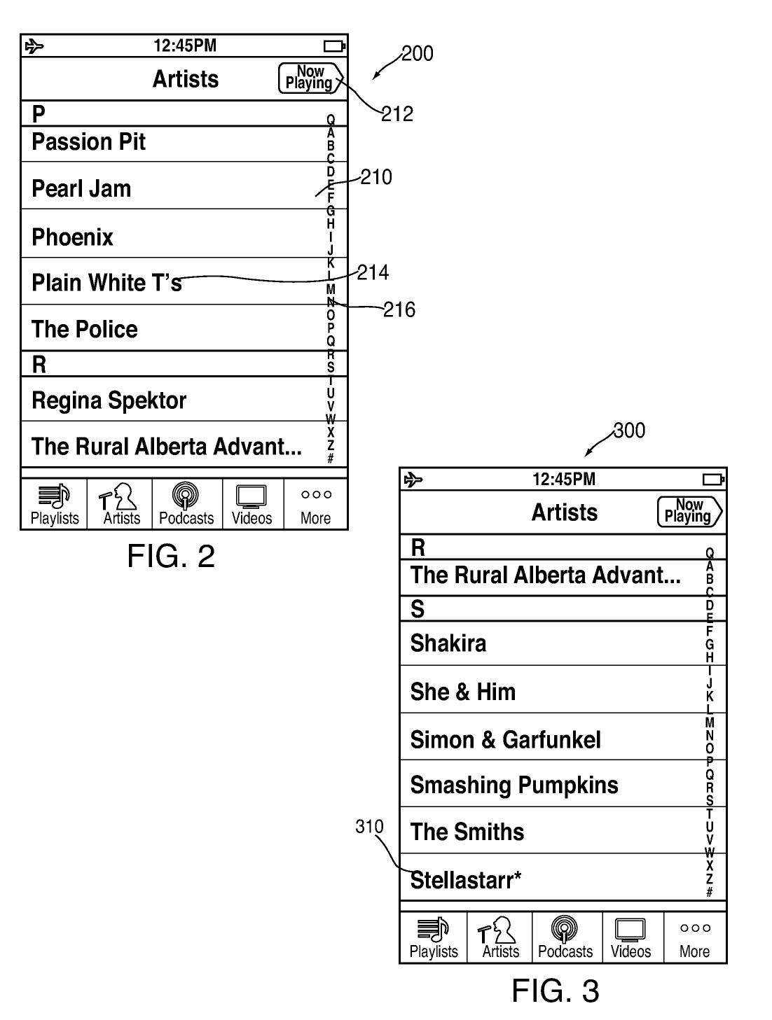

The electronic device can display any suitable text to a user of the device. FIG. 2 is a schematic view of an illustrative electronic device display depicting a text listing in accordance with one embodiment of the invention. Display 200 can include any suitable information for the user, including for example textual listings of data or media available from the electronic device (e.g., listing 210 of songs). Listing 210 can be generated by the display circuitry using any suitable approach, including for example by displaying glyphs associated with each character of the listing. For example, listing 210 can include glyphs associated with each of header 212, artist 214, and alphabet 216. In the particular example of display 200, all of glyphs correspond to letters of the Latin alphabet. Because the fonts, colors and sizes of the characters in each of header 212, artist 214 and alphabet 216 vary, however, different glyphs may be required for both the individual characters of each of the displayed elements, and the same character in different elements (e.g., different glyphs for the letter “R” in artists 214 and alphabet 216).

When the electronic device first receives a request to display a display such as display 200, the device can initially load the required glyphs in cache. Alternatively, if the device already has some glyphs stored in cache, the device can review the cache to determine whether the required glyphs are available. When a glyph is missing from cache, the device can read the glyph from storage and load the missing glyph to the cache. If the cache is full, a previously loaded glyph can be flushed (e.g., the oldest glyph in cache in a first-in first-out model).

In some embodiments, display 200 can be scrolled or modified to view different information. For example, FIG. 3 is a schematic view of an illustrative display depicting a different section of the text listing of FIG. 2 in accordance with one embodiment of the invention. Display 300 can include listing 310 of information (e.g., artists) that differs from listing 210 (FIG. 2). For example, display 300 can include a scrolled down section of the artist listing. Because the particular text of listing 310 differs from that of listing 210, the electronic device can require different glyphs for displaying listing 310. To display the characters of listing 310, the device can review the cache to retrieve the glyphs corresponding to the characters. To the extent that the glyphs match those required for listing 210, the glyphs will likely be available in cache (e.g., glyphs for the characters ‘a,’ ‘s,’ ‘n,’ ‘t’ . . . ). Listing 310, however, can include other characters for which the glyphs will likely not be in cache (e.g., ‘S,’ ‘&,’ ‘*’ . . . ). The device may then be required to read the missing glyphs from storage.

Based on the size of the cache and the number of glyphs previously stored in cache, the device may or not be required to flush previous glyphs to store the retrieved glyphs. To ensure that the cache use is most efficient, the electronic device can define a variable hit rate from which the cache size can be selected. For example, the electronic device can define a hit rate as a percentage of requested glyphs that must be available directly from cache (e.g., 97%). If less than 97% of requested glyphs are available from the cache, the electronic device can read the missing glyphs from storage, and increase the cache size to include them. Alternatively, if more than 97% of the requested glyphs are available from the cache, the electronic device can retrieve the requested glyphs from cache and subsequently purge the cache to reduce its size (e.g., because a hit rate higher than 97% is indicative of an overly large cache).

The cache size can vary in any suitable increment from any suitable initial cache size. For example, the glyph cache can initially be 6 KB, and subsequently grow or reduce in 2 KB increments. Any other size or increment can be used, however (e.g., different increments for growing and reducing the cache). To ensure that the hit rate remains relevant after displaying many displays can characters, the electronic device can flush the cache and reset the hit rate each time a new display is rendered. This can prevent the device from inefficiently moving to an equilibrium in which the device-wide most common glyphs are loaded in the cache, but the most common glyphs of the current display are not loaded in the cache.

The hit rate can vary based on any suitable criteria. For example, the hit rate can vary based on the size of displayed fonts (i.e., on the number of characters displayed on a particular display), such that the hit rate for larger fonts is reduced due to the fewer glyphs required to render the display. Alternatively, the hit rate can vary based on the type of character and corresponding glyph displayed. For example, when the language or alphabet used changes, the electronic device can retain in cache all glyphs associated with numbers (e.g., require a high hit rate) but change the hit rate of characters associated with letters in each of the alphabets or other collections of characters (e.g., change a first hit rate for English characters and for second hit rate for Chinese characters).

In some embodiments, the electronic device can apply a heuristic to change the hit rate on the fly when the device detects a change in alphabet. For example, if the device is set up with English as a default language (or any other language using the Latin alphabet), but detects a character string in Japanese, the device can retain the hit rate associated with English, but define a significantly lower hit rate for the Japanese characters (e.g., 50% hit rate). If the device, however, detects a large or significant succession of Japanese characters (e.g., a series of albums by a Japanese artist), the Japanese hit rate can increase while the English hit rate can be reduced to control the cache size. The heuristics, therefore, can cause the hit rate to change as a new display is rendered or when new characters are rendered in a particular display. In addition, the applied hit rate can vary based on a hit rate associated with a series of characters being rendered (e.g., apply a Chinese character hit rate to Chinese characters and an English character hit rate to English characters).

In some embodiments, the hit rate can vary based on criteria or events external to the processing and rendering of characters or other glyph-based display elements. For example, if the device determines that another process needs additional cache or system memory, the electronic device can reduce the hit rate to free up memory for the other process (e.g., a memory intensive UI).

When the electronic device sleeps or hibernates, the glyph cache can be flushed or otherwise lost. When the device later wakes from sleep or hibernation, the glyph cache can be rebuilt by accessing storage. Alternatively, the glyph cache can write its current state to storage before sleep or hibernation (e.g., saving information about the current state of cache and what was cached) so that the glyph cache can be restored upon wake. This approach can reduce piecemeal storage access for rebuilding the glyph cache, and can also provide accurate usage information about glyph usage, which in turn can be used to adjust the hit rate heuristic.

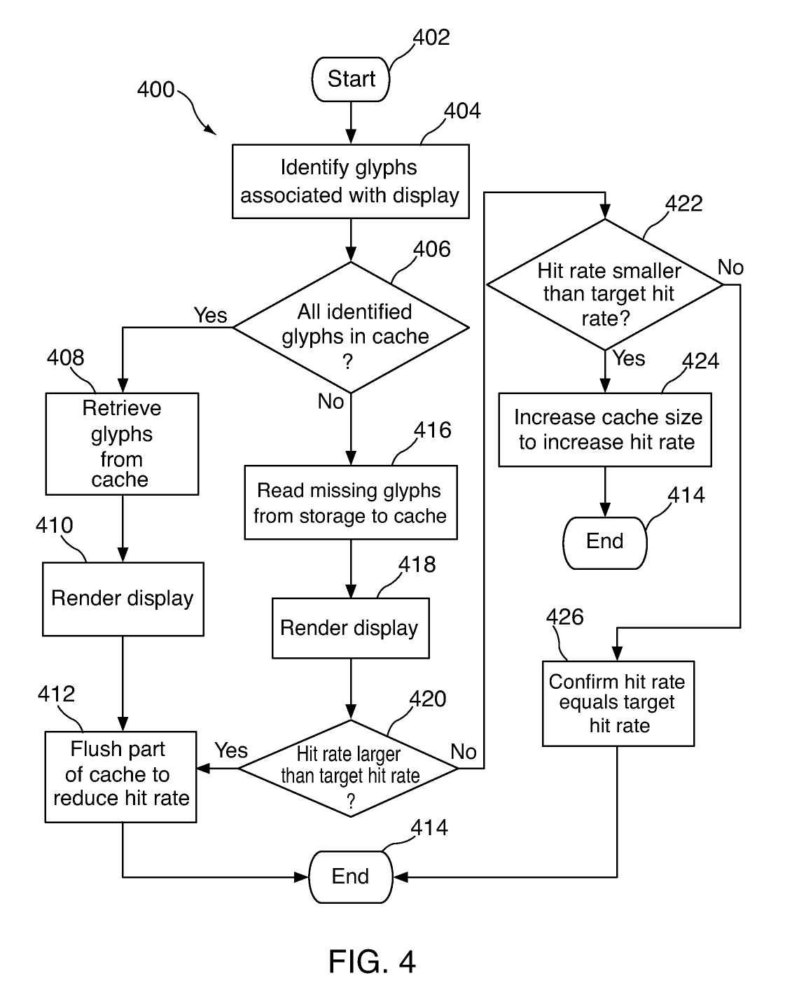

FIG. 4 is a flowchart of an illustrative process for managing the cache size in accordance with one embodiment of the invention. Process 400 can begin at step 402. At step 404, the electronic device can identify glyphs associated with a particular display to be provided to the user. For example, the electronic device can identify the characters of the display, and the glyphs associated with the particular characters (e.g., based on the font, color and size of the characters on the display). At step 406, the electronic device can determine whether all of the glyphs required to render the display are in cache. For example, the electronic device can determine whether all of the fonts are loaded in system memory or cache. If the electronic device determines that all of the required fonts are loaded in cache, process 400 can move to step 408.

At step 408, the electronic device can retrieve the required glyphs from cache, and at step 410 the electronic device can render the display using the retrieved glyphs. Because all of the glyphs required were available from cache, the hit rage for the display was 100%, and thus necessarily higher than the target hit rate (provided the target hit rate is less than 100%, which may require a very large cache). At step 412, the electronic device can therefore flush a portion of the cache (e.g., the oldest glyphs stored in the cache) to reduce the cache size and reach the target hit rate. Process 400 can then end at step 414.

If, at step 406, the electronic device instead determines that all of the identified glyphs are not loaded in cache, process 400 can move to step 416. At step 416, the electronic device can read the missing glyphs from storage to cache, and at step 418 can render the display with all of the required glyphs. At step 420, the electronic device can determine whether the hit rate for the current display is larger than the target hit rate. For example, the electronic device can determine whether the hit rate is in between the target rate of 97% and 100%. If the electronic device determines that the hit rate is larger than the target hit rate, process 400 can move to step 412, described above.

If, at step 420, the electronic device instead determines that the hit rate is not larger than the target hit rate, process 400 can move to step 422. At step 422, the electronic device can determine whether the hit rate is smaller than the target hit rate. For example, the electronic device can determine whether the hit rate is less than 97%. If the electronic device determines that the hit rate is less than the target hit rate, process 400 can move to step 424. At step 424, the electronic device can increase the cache size to increase the resulting hit rate (e.g., more glyphs will be stored in a larger cache, and therefore more requested glyphs will be pre-loaded in cache). Process 400 can then move to step 414 and end.

If, at step 422, the electronic device instead determines that the hit rate is not smaller than the target hit rate (i.e., the hit rate is neither larger nor smaller than the target hit rate), process 400 can move to step 426 and confirm that the actual hit rate is equal to the target hit rate. This also can allow the electronic device to confirm that the cache size is correct. Process 400 can then move to step 414 and end.

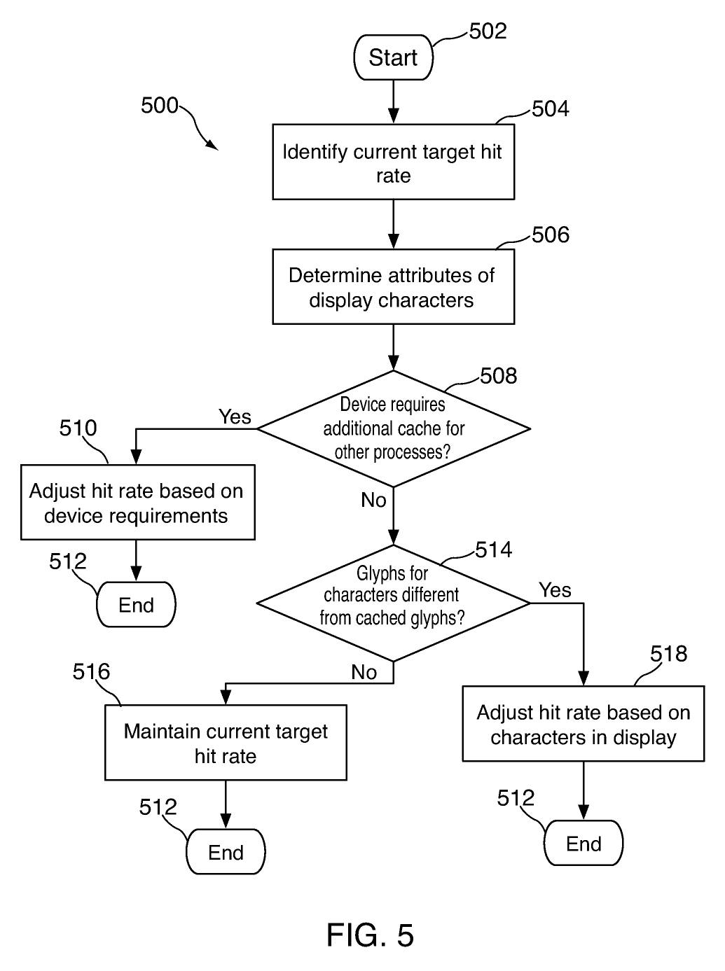

FIG. 5 is a flowchart of an illustrative process for adjusting a target hit rate in accordance with one embodiment of the invention. Process 500 can begin at step 502. At step 504, the electronic device can identify a current target hit rate. For example, the electronic device can determine that the current target hit rate is that associated with a particular type of character. As another example, the electronic device can determine that the current target hit rate is equal to the default hit rate. At step 506, the electronic device can determine the identity or attributes of the characters to be displayed in a current or upcoming display. For example, the electronic device can determine that some or all of the characters are associated with glyphs that are distinct from the glyphs currently loaded in cache (e.g., characters in a different alphabet). Alternatively, the electronic device can determine that some or all of the characters require glyphs similar to those already loaded in cache. At step 508, the electronic device can determine whether additional cache is required for other processes (e.g., not textual display processes). For example, the electronic device can determine whether a user interface requires additional cache to process inputs. If the electronic device determines that additional cache is required, process 500 can move to step 510 and adjust the hit rate based on the device requirements. For example, the electronic device can reduce the hit rate to free up cache for other processes. Process 500 can then end at step 512.

If, at step 508, the electronic device instead determines that the device does not require additional cache, process 500 can move to step 514. At step 514, the electronic device can determine whether the glyphs for characters of the current or upcoming display are different from the glyphs loaded in cache. For example, the electronic device can determine whether a character to be rendered is in the same or different alphabet as the characters for which glyphs are loaded in cache. If the electronic device determines that the glyphs are the same, process 500 can move to step 516. At step 516, the electronic device can maintain the current hit rate. Process 500 can then end at step 512.

If, at step 514, the electronic device instead determines that the glyphs are different, process 500 can move to step 518. At step 518, the electronic device can adjust the hit rate based on the identity or attributes of the characters to display. For example, the electronic device can reduce the hit rate of English glyphs and increase the hit rate of Korean glyphs upon detecting that Korean characters are being displayed. Process 500 can then end at step 512.

Although many of the embodiments of the present invention are described herein with respect to personal computing devices, it should be understood that the present invention is not limited to personal computing applications, but is generally applicable to other applications.

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The above described embodiments of the invention are presented for purposes of illustration and not of limitation, and the present invention is limited only by the claims which follow.

What is claimed is:

1. A method for adjusting the amount of glyphs stored in cache, comprising:
identifying glyphs to display;
determining the number of identified glyphs available from a cache;
comparing the determined number to a target hit rate; and
adjusting the amount of glyphs loaded in the cache in response to comparing.

2. The method of claim 1, further comprising:
determining that the number of identified glyphs available from cache is less than the target hit rate; and
increasing the amount of glyphs loaded in the cache in response to determining that the number of identified glyphs is less than the target hit rate.

3. The method of claim 2, further comprising:
increasing the amount of glyphs loaded by predetermined increments.

4. The method of claim 3, wherein:
increasing further comprises increasing the size of the cache.

5. The method of claim 1, further comprising:
determining that the number of identified glyphs available from cache is more than the target hit rate; and
decreasing the amount of glyphs loaded in the cache in response to determining that the number of identified glyphs is more than the target hit rate.

6. The method of claim 5, wherein:
decreasing further comprises flushing a portion of the cache.

7. The method of claim 1, wherein:
the hit rate is defined as a percentage of requested glyphs available from the cache.

8. The method of claim 7, wherein:
the default hit rate is 97%.

9. The method of claim 1, further comprising:
detecting glyphs to display not available from the cache;
reading the detected glyphs from a storage; and
loading the read glyphs to the cache.

10. An electronic device having a variable cache size for glyphs, comprising a display, storage, memory, and a processor, the processor operative to:
identify glyphs for display by the display;
retrieve a subset of the identified glyphs from the memory;
read the remaining identified glyphs from storage;
load the read glyphs in memory;
compare the number of identified glyphs in the subset with a target hit rate; and
adjust the number of glyphs loaded in memory based on the comparison.

11. The electronic device of claim 10, wherein the processor is further operative to:
render the identified glyphs; and
direct the display to display the rendered glyphs.

12. The electronic device of claim 10, wherein the processor is further operative to:
define a cache in memory for loading the glyphs, wherein the cache has an initial size; and
adjust the size of the cache by increments.

13. The electronic device of claim 12, wherein:
the initial cache size is 6 KB; and
the increment size is 2 KB.

14. The electronic device of claim 12, wherein the processor is further operative to:
compare the percentage of the identified glyphs loaded in memory with the hit rate.

15. The electronic device of claim 14, wherein the control circuitry is further operative to:
determine that the percentage of glyphs loaded in memory is less than the hit rate; and
increase size of the cache in response to determining that the percentage of glyphs loaded in memory is less than the hit rate.

16. The electronic device of claim 10, wherein the processor is further operative to:
determine that the identified glyphs are associated with a first alphabet, wherein a first hit rate is associated with the first alphabet;
identify a plurality of future glyphs to display, wherein the plurality of future glyphs are associated with a second alphabet and wherein a second hit rate is associated with the second alphabet; and
adjust the first hit rate relative to the second hit rate in response to identifying the plurality of future glyphs.

17. A method for adjusting a hit rate associated with loading glyphs in a system memory, comprising:
defining an initial hit rate for retrieving glyphs loaded in memory, wherein the hit rate defines the number of glyphs requested for rendering a display that are initially loaded in memory;
determining that a set of characters to display are associated with a different collection of characters than characters corresponding to the glyphs initially loaded in memory; and
reducing the hit rate to limit the number of the glyphs associated with the different collection of characters loaded in memory.

18. The method of claim 17, further comprising:
determining that additional characters associated with the different collection of characters are to be displayed; and
increasing the hit rate.

19. The method of claim 17, wherein:
the glyphs initially loaded in memory correspond to a first alphabet; and
the set of characters correspond to a second alphabet, wherein the first alphabet is different from the second alphabet.

20. The method of claim 19, further comprising:
a first hit rate associated with the first alphabet; and
a second hit rate associated with the second alphabet.

21. Computer readable media for adjusting the amount of glyphs stored in cache, comprising computer readable code recorded thereon for:
identifying glyphs to display;
determining the number of identified glyphs available from a cache;
comparing the determined number to a target hit rate; and
adjusting the amount of glyphs loaded in the cache in response to comparing.

22. The computer-readable media of claim 21, comprising further computer readable code recorded thereon for:
determining that the number of identified glyphs available from cache is less than the target hit rate; and
increasing the amount of glyphs loaded in the cache in response to determining that the number of identified glyphs is less than the target hit rate.
The computer-readable media of claim 21, comprising further computer readable code recorded thereon for:
determining that the number of identified glyphs available from cache is more than the target hit rate; and
decreasing the amount of glyphs loaded in the cache in response to determining that the number of identified glyphs is more than the target hit rate.
